(19) United States
(12) Patent Application Publication
(10) Pub. No.: US 2008/0275721 A1
(43) Pub. Date: Nov. 6, 2008

(54) Information Terminal and Health Care Assisting System

(75) Inventors: Kazutoshi Nagai, Kanagawa (JP); Jinsei Miyazaki, Osaka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/570,592

(22) PCT Filed: Jul. 1, 2005
(86) PCT No.: PCT/JP2005/012222

§ 371 Date: Dec. 14, 2006

(30) Foreign Application Priority Data
Jul. 1, 2004 (JP) 2004-195375

(51) Int. Cl. G06Q 50/00; G06Q 10/00

(52) U.S. Cl. 705/2; 707/10; 707/E17.01

(57) ABSTRACT

The invention is intended for making it possible for the user to get appropriate advice not only based on biological information, but also considering the situation of health care to be taken by the user as for article intake.

Food information of food ingredients, food-contained calories, etc., described on a package, etc., of food incepted by the user is input to a patient terminal 4 through food information input means 3 for inputting the food information and the food information is transmitted to a server 1 via a communication line 2.

### TECHNICAL FIELD

This invention relates to an information terminal having a function of collecting biological information and a health care support system including the information terminal.

### BACKGROUND ART

Hitherto, a health care support system made up of a patient terminal for collecting health information, etc., containing measurement information of the living body of the user requiring health care and information of answers to the inquiries made by doctors, etc., and a biological information receiver for receiving the health information, etc., via a communication line has been researched. In this kind of health care support system, hitherto, it has been a common practice to receive the measurement information of the living body in a server of a biological information receiver (refer to patent document 1).

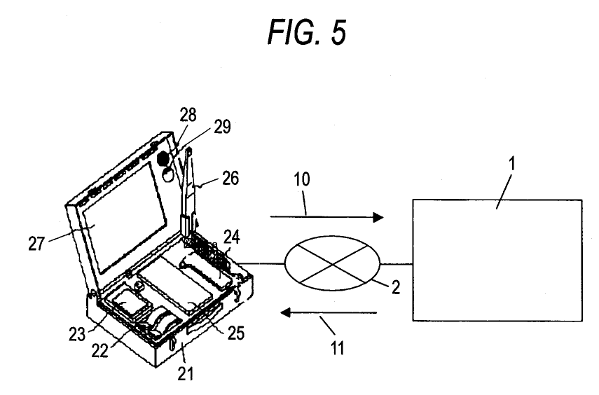

FIG. 5 is a system drawing of a health care support system in a related art; it shows the health care support system in the related art using an apparatus described in the gazette (which will be hereinafter referred to as electronic emergency medical kit). An electronic emergency medical kit 21 of a biological information collecting apparatus houses a blood pressure manometer 22, an electrocardiograph 23, an auricular thermometer 24, a blood sugar meter 25, an electronic scope 26, etc. It also incorporates a display 27, a loudspeaker 28, a microphone 29, etc. The user collects measurement information (biological information) of the body temperature, the blood pressure value, etc., measured with the auricular thermometer 24, the auricular thermometer 24, etc., in the electronic emergency medical kit 21 of a biological information collecting apparatus. Inquiry answer information and measurement information 10 are sent to a server 1 of a biological information receiver installed in a medical institution, etc., connected by a communication network 2 of a telephone line, etc., connected to the electronic emergency medical kit 21.

In the health care support system in the related art, however, the biological information collecting apparatus sends the current biological information of the user such as the body temperature and the blood pressure value to the biological information receiver and thus in the medical institution, etc., receiving the information, medical staff cannot give the user appropriate guidance considering the situation of health care to be taken by the user, namely, sufficient health advice although the medical staff can give the user advice based on the current health condition.

Patent document 1: JP-A-2000-83907

### DISCLOSURE OF THE INVENTION

### Problems to be Solved by the Invention

It is therefore an object of the invention to provide an information terminal and a health care support system including the information terminal for making it possible for the user to get appropriate advice not only based on biological information, but also considering the situation of health care to be taken by the user as for article intake.

### Means for Solving the Problems

The information terminal of the invention is an information terminal having a function of collecting biological information, the information terminal including information input means for inputting intake information of an article incepted by the user, information storage means for storing the input intake information, and information transmission means for transmitting the stored intake information. According to the configuration, the information terminal includes the information input means for inputting intake information of an article incepted by the user, whereby the intake information and the biological information can be transmitted to an information terminal installed in a hospital, etc., so that it is made possible for the user to get appropriate advice not only based on the biological information, but also considering the situation of health care to be taken by the user as for article intake of food, medicine, etc.

The information terminal of the invention is characterized in that the information input means includes a device for reading the intake information. The information terminal of the invention is characterized in that the information input means includes a bar code reader for reading a bar code given to a package, etc., of the article incepted by the user. The information terminal of the invention is characterized in that the information input means includes read means for reading the intake information from an electronic tag given to a package, etc., of the article incepted by the user. According to the configuration, the intake information is read, whereby the intake information can be automatically input, so that an input value error and an error of omission of a necessary item are eliminated and correct and reliably input can be executed. Erroneous input of information described on package paper, etc., of food, etc., and the inconvenience of information input can be decreased and the information terminal can be used still more reliably and easily.

The information terminal of the invention is characterized in that the information input to the information input means includes information of the time at which the user incepts the article, the intake amount, etc.

The information terminal of the invention is characterized in that the information input means is placed detachably in a main unit of the terminal and has storage means for storing input information and transmission means for transmitting the stored information to the main unit of the terminal. According to the configuration, only the information input means is carried without carrying the main unit of the terminal, whereby it is made possible to use at the destination.

The information terminal of the invention is characterized in that the information terminal includes information reception means for receiving advice information based on the transmitted information. The information terminal of the invention is characterized in that the advice information includes at least one of a list of foods to be incepted and medicines to be taken, order guide information thereof, and information of the most suitable hospital name or doctor name. According to the configuration, the advice information based on the transmitted information is received, whereby the advice information can be sent reliably to the user without using mail, telephone, etc.

The information terminal of the invention is characterized in that the information terminal includes selection means for selecting the advice information and transmitting the selection description. According to the configuration, information as to which description is selected out of the received advice information can be sent to an information terminal installed in a hospital, etc., so that it is made possible to make arrangements for food, arrangements for medicine, arrangements for hospital, arrangements for doctor, and the like in the hospital, etc, based on the received information.

The health care support system of the invention is a health care support system including the information terminal of the invention and an advice information providing information terminal including communication means for receiving information transmitted from the information terminal and transmitting advice information based on the received information to the information terminal via a communication line. The health care support system of the invention is characterized in that the communication line includes the Internet.

Further, the health care support system of the invention is characterized in that the advice information providing information terminal includes arrangement means for making at least one type of arrangements for food, arrangements for medicine, arrangements for hospital, and arrangements for doctor.

### ADVANTAGES OF THE INVENTION

According to the invention, the user enters intake information of an article incepted by the user, whereby the intake information and the biological information can be transmitted to the information terminal installed in the hospital, etc., so that it is made possible for the user to get appropriate advice not only based on the biological information, but also considering the situation of health care to be taken by the user as for article intake.

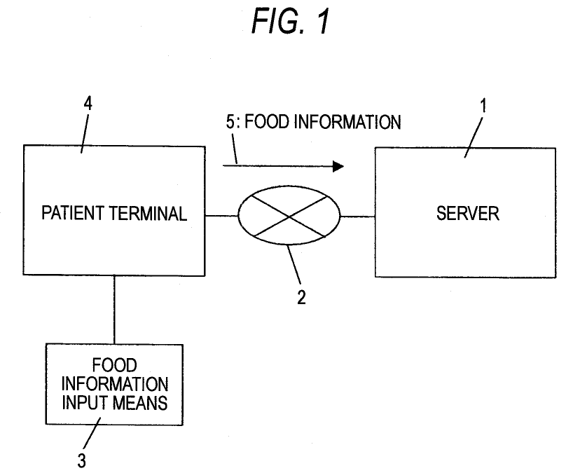

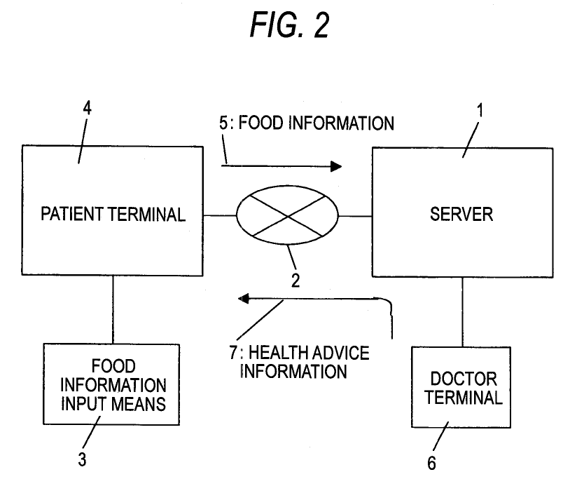

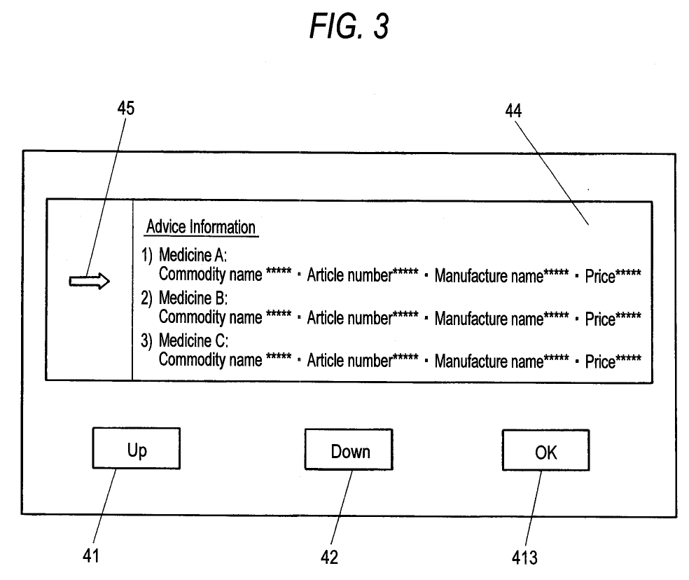

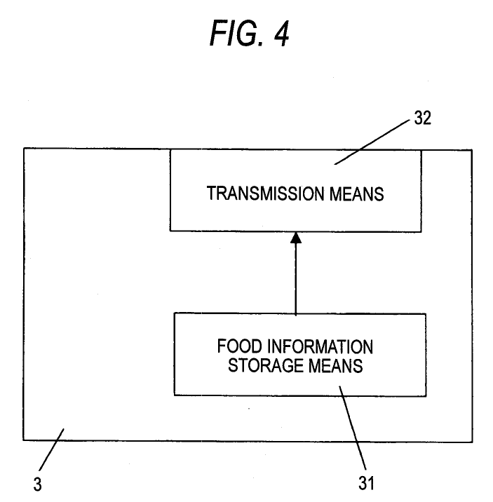

### BRIEF DESCRIPTION OF THE DRAWINGS

[FIG. 1] A system drawing of a health care support system in a first embodiment of the invention.

[FIG. 2] A system drawing of a health care support system in a second embodiment of the invention.

[FIG. 3] An external view of an operation display section of a patient terminal having selection means for selecting advice information in the second embodiment of the invention and transmitting the selected description.

[FIG. 4] A block diagram of food information input means 3 of a health care support system in a fourth embodiment of the invention.

[FIG. 5] A system drawing of a health care support system in a related art.

### DESCRIPTION OF REFERENCE NUMERALS

1 Server
2 Communication line
3 Food information input means
31 Food information storage means
32 Transmission means
4 Patient terminal
41 Operation part (cursor up key)
42 Operation part (cursor down key)
43 Operation part (set key)
44 Advice information displayed in display section
45 Cursor displayed in display section
5 Food information (patient terminal to biological information collection apparatus)
6 Doctor terminal
7 Health advice information (doctor terminal to patient terminal)

### BEST MODE FOR CARRYING OUT THE INVENTION

Embodiments of the invention will be discussed with reference to the accompanying drawings.

### FIRST EMBODIMENT

FIG. 1 is a system drawing of a health care support system in a first embodiment of the invention. Components identical with those in FIG. 5 are denoted by the same reference numerals in FIG. 1 and will not be discussed again.

The health care support system shown in FIG. 1 contains a patient terminal 4 having a function of collecting biological information of patient (user) and communication means (not shown) for receiving the information transmitted from the patient terminal 4 and transmitting advice information based on the received information to the patient terminal 4 via a communication line 2, and includes a server 1 for collecting the patient information. The patient terminal 4 is installed in the house, etc., of the patient (user) requiring health care, and the server 1 is installed in a hospital, etc. In FIG. 1, numeral 3 denotes food information input means such as a keyboard built in the patient terminal 4 for entering intake information of foods incepted by the user (food information). The user uses the food information input means 3 to enter food information. The entered food information is recorded in storage means (not shown) provided in the patient terminal 4. The patient terminal 4 is connected to the server 1 and transmits the stored biological information and food information to the server 1 via the communication line 2 of the Internet, etc.

According to the configuration, food information, etc., can be transmitted to the server 1 installed in a hospital, etc., through the patient terminal 4, so that the food information can be provided for the administrator of the health care support system (the administrator may be a doctor or a hospital of an individual or an organization having medical knowledge different from the administrator for administrating the system), and the user can be given advice based on the information from the administrator. Accordingly, it is made possible for the user to get appropriate advice not only based on the biological information, but also considering the situation of health care to be taken by the user as for article intake; the user can be given more appropriate guidance on health care.

In the embodiment, the food information input means is a keyboard, but may be a touch panel or voice input. The communication line 2 may be a telephone line or the Internet or may be wired or wireless.

### SECOND EMBODIMENT

FIG. 2 is a system drawing of a health care support system in a second embodiment of the invention. Components identical with those in FIG. 2 are denoted by the same reference numerals in FIG. 1 or 5 and will not be discussed again.

In FIG. 2, numeral 6 denotes a doctor terminal connected to a server 1 for receiving information transmitted from a patient terminal 4. A doctor, etc., checks food information of each terminal through the doctor terminal 6. After checking the food information, the doctor, etc., transmits health advice information 7 for each patient from the doctor terminal 6 to the patient terminal 4.

According to the configuration, the administrator, the doctor, etc., gives guidance and advice on health in the same system and thus need not use another arrangement of mail, telephone, etc., and can reliably give the patient guidance and advice on health. The description of the health advice is changed depending on the type and level of disease of the patient, whereby it is made possible to give more appropriate health advice and the advice description can be enriched. If a list of foods to be incepted and medicines to be taken by the user and order information thereof, information of the most suitable hospital names and doctor names, and the like are contained in the health advice information, it is very convenient for the user. Further, if ordering of the food to be incepted or the medicine to be taken by the user and arrangements for the most suitable hospital or doctor are automatically conducted in the doctor terminal based on the information, the need for the user to make arrangements is eliminated and therefore it is very convenient for the user.

FIG. 3 is an external view of an operation display section of the patient terminal having selection means for selecting advice information in the second embodiment of the invention and transmitting the selected description.

In FIG. 3, numerals 41 to 43 denote operation parts (selection means). Numeral 44 denotes health advice information (in the example, medicine information) and numeral 45 denotes a cursor for selecting health advice information, displayed in the display section. The operation part 41 is a cursor up key for moving the cursor 45 upward, the operation part 42 is a cursor down key for moving the cursor 45 downward, and the operation part 43 is a set key for transmitting the health advice information selected with the cursor 45 (pointed to by the cursor 45) to the server 1.

According to the configuration, the user uses the operation parts 41 and 42 to select the medicine which seems to be suited to the user according to the commodity name, the manufacturer name, the price, etc., from among the medicines to be taken in the health advice information 44 displayed on the patient terminal with his or her intention and presses the operation part 43, thereby transmitting the selection description to the server 1. On the other hand, the doctor terminal 6 is provided with arrangement means for making at least one type of arrangements for food, arrangements for medicine, arrangements for hospital, and arrangements for doctor, whereby the doctor terminal 6 receiving the information selected in the patient terminal 4 can make arrangements for ordering the medicine from the medicine manufacturer or the like based on the information selected by the user. In the example, medicine information is taken as the health advice information, but the health advice information may be information of the food to be incepted, the most suitable hospital name or doctor name for the user, etc.

### THIRD EMBODIMENT

In a third embodiment, a bar code reader (not shown) for reading a bar code described on a food package, etc., or a reader (not shown) for reading an electronic tag attached to a food, a food package, etc., is used as food information input means 3.

According to the configuration, food information can be automatically input as it is read, so that the need for the user to read text information printed on a food package, etc., and enter the text or input voice using a keyboard, etc., is eliminated and thus the food information can be input reliably and correctly to a patient terminal 4. Therefore, the user can be prevented from being given erroneous guidance based on erroneously input food information, and correct and appropriate health advice with good accuracy is made possible. Particularly, it is made possible to collect a larger amount of information by reading an electronic tag. Further, it is made possible to input information from an electronic tag simply by placing the reader in the proximity of the electronic tag and it is not necessary to take special care when inputting the food information; it is very convenient for the user. This point is very important in inputting the food information by the patient.

### FOURTH EMBODIMENT

FIG. 4 is a block diagram of food information input means 3 in a fourth embodiment of the invention. In the embodiment, food information storage means 31 and transmission means 32 to a patient terminal are added to the food information input means 3, whereby the food information input means can be detached from a patient terminal 4. For example, if the user detaches the food information input means 3 from the patient terminal 4 for use on a trip, etc., input food information is stored in the food information storage means 31. After returning home, the user transmits the food information to the patient terminal 4 through the transmission means 32.

According to the configuration, when the user moves on a trip, etc., food information can also be collected easily at the destination if the user possesses only the detachable food information input means 3 without carrying the patient terminal 4 main unit. According to the configuration, it is made possible to carry the food information input means for use, and use is also made possible when the user goes out on a trip, etc.

In addition to the food information, information of the amount of food incepted by the user and the time at which the user incepts food may also be entered. Accordingly, it is made possible for the user to be given still more appropriate guidance.

The patient terminal 4 and the server 1 are connected by a communication line including the Internet, whereby it is made possible to use the communication line at very low cost in connection from a remote location, and it is made possible to implement an inexpensive system.

In the description given above, information of food incepted by the user requiring health care is sent to the administrator of the health care support system by way of example, but the invention can also be applied to the use of sending information of the medicine taken by the user to the administrator as described above in place of the food information.

The health care support system described above has the very large advantage that the information of the food incepted by the user requiring health care can be sent precisely to the administrator of the doctor, etc., for administrating the health care support system and thus the user can be given more appropriate guidance on health care from the administrator. The system of the invention is very effective particularly in these days of describing ingredients and calories on a large number of foods and frequently making the most of instant foods, etc., in an almost complete state (cooking is less required).

A bar code reader for reading a bar code described on a food package, etc., and an electronic tag are included in the food information input means, whereby it is made possible to prevent erroneous entry of the user and erroneous guidance caused by the erroneous entry, and still more appropriate guidance can be given.

Further, intake information of the intake time, the intake amount, etc., of food is included in the information input to the food information input means, whereby accuracy of guidance can be enhanced and still more precise guidance is made possible.

The food information input means is made detachable, whereby it is made possible to input food information continuously as the user carries only the food information input means when the user goes out. The system has a very large advantage in food information collection which is significant as it continues for days, such as food information collection for a chronic disease of diabetes, etc.

While the invention has been described in detail with reference to the specific embodiments, it will be obvious to those skilled in the art that various changes and modifications can be made without departing from the spirit and the scope of the invention.

The present application is based on Japanese Patent Application (No. 2004-195375) filed on Jul. 1, 2004, which is incorporated herein by reference.

### INDUSTRIAL APPLICABILITY

The information terminal and the health care support system of the invention have the advantage that the intake information and the biological information can be transmitted to the information terminal installed in the hospital, etc., and thus it is made possible for the user to get appropriate advice not only based on the biological information, but also considering the situation of health care to be taken by the user as for article intake; the invention is useful for an information terminal having a function of collecting biological information, a health care support system including the information terminal, and the like.

1: An information terminal having a function of collecting biological information, the information terminal comprising:
an information input unit which inputs intake information of an article incepted by a user;
an information storage unit which stores the input intake information; and
an information transmission unit which transmits the stored intake information.

2: The information terminal according to claim 1, wherein the information input unit includes a device for reading the intake information.

3: The information terminal according to claim 2, wherein the information input unit includes a bar code reader for reading a bar code given to a package, etc., of the article incepted by the user.

4: The information terminal according to claim 2, wherein the information input unit includes a read unit which reads the intake information from an electronic tag given to a package, etc., of the article incepted by the user.

5: The information terminal according to claim 1, wherein the information input to the information input unit includes information of the time at which the user incepts the article, the intake amount, etc.

6: The information terminal according to claim 1,
wherein the information input unit is placed detachably in a main unit of the terminal, and
wherein the information input unit comprises:
a storage unit which stores input information; and
a transmission unit which transmits the stored information to the main unit of the terminal.

7: The information terminal according to claim 1, wherein the information terminal comprises an information reception unit which receives advice information based on the transmitted information.

8: The information terminal according to claim 7, wherein the advice information includes at least one of a list of foods to be incepted and medicines to be taken, order guide information thereof, and information of the most suitable hospital name or doctor name.

9: The information terminal according to claim 7, wherein the information terminal further comprises a selection unit which selects the advice information and transmitting the selection description.

10: A health care support system comprising:
an information terminal according to claim 1; and
an advice information providing information terminal comprising a communication unit which receives information transmitted from the information terminal and transmitting advice information based on the received information to the information terminal via a communication line.

11: The health care support system according to claim 10, wherein the communication line includes the Internet.

12: The health care support system according to claim 10, wherein the advice information providing information terminal further comprises an arrangement unit which makes at least one type of arrangements for food, arrangements for medicine, arrangements for hospital, and arrangements for doctor.

13: A health care support system comprising:
an information terminal according to claim 9; and
an advice information providing information terminal comprising:
a communication unit which receives information transmitted from the information terminal and transmitting advice information based on the received information to the information terminal via a communication line; and
an arrangement unit which makes at least one type of arrangements for food, arrangements for medicine, arrangements for hospital, and arrangements for doctor based on the information selected through the selection unit.
